(19) United States
(12) Patent Application Publication
(10) Pub. No.: US 2025/0284042 A1
(43) Pub. Date: Sep. 11, 2025

(54) NEAR-INFRARED-FILTERING THERMAL-ISOLATIVE OPTICAL LENS DEVICE AND METHOD THEREOF FOR WHOLE-VISIBLE-SPECTRUM ENHANCEMENT

(71) Applicant: FORESIGHT OPTICAL LTD., Tainan (TW)

(72) Inventors: TIEN-SHU WU, Tainan (TW); YEN-TING WU, Tainan (TW); HO-LUN CHEN, Tainan (TW)

(21) Appl. No.: 18/645,168

(22) Filed: Apr. 24, 2024

Related U.S. Application Data
(63) Continuation-in-part of application No. 18/600,528, filed on Mar. 8, 2024.

(30) Foreign Application Priority Data
Mar. 11, 2024 (TW) 113108873

(51) Int. Cl. G02B 5/20; G02B 5/00

(52) U.S. Cl. CPC G02B 5/208; G02B 5/003

(57) ABSTRACT

An optical lens device includes a lens body, an optical filter and an optical absorbance portion. The optical absorbance portion has a violet & UV absorbent region and a red & NIR absorbent region between which forms a whole-visible-spectrum transmittance region. The whole-visible-spectrum transmittance region is located between a first transmittance wavelength at 405 nm and a second transmittance wavelength at 710 nm. The violet & UV absorbent region is provided to absorb a violet light and a UV light of beams while the red & NIR absorbent region is provided to absorb a red light and a NIR light of beams.

### CROSS REFERENCE TO RELATED APPLICATIONS

This application is a continuation-in-part of U.S. patent application Ser. No. 18/600,528, filed on Mar. 8, 2024, which is hereby incorporated by reference in its entirety.

### BACKGROUND OF THE INVENTION

### 1. Field of the Invention

The present invention relates to an infrared-filtering thermal-isolative optical lens device and method thereof for whole-visible-spectrum enhancement. Particularly, the present invention relates to the near-infrared-filtering thermal-isolative optical lens device and method thereof with violet-filtering and ultraviolet-filtering for whole-visible-spectrum enhancement.

### 2. Description of the Related Art

PCT (Patent Cooperation Treaty) Patent Pub. No. WO-2008/133008, entitled “INFRARED RAY-ABSORBABLE EYEGLASSES LENS, AND METHOD OF PRODUCTION THEREOF,” discloses an infrared ray-absorbable eyeglasses lens and a production method thereof. The infrared ray-absorbable eyeglasses lens includes an infrared ray absorbent.

As mentioned above, the infrared ray-absorbable eyeglasses lens is formed from a resin further including a prepolymer which is formed by polymerization reacting polyisocyanate and polyhydroxy compound, with addition polymerization reacting the prepolymer with aromatic polyamine to form a poly urethane resin. There does not utilize any peroxide additive in the addition polymerization reaction.

As mentioned above, the poly urethane resin includes an infrared ray absorbing dye which can absorb infrared rays having a wavelength ranging between 780 nm and 2500 nm, with suppressing (blocking or filtering) the infrared rays having an average transmittance of 30% or less.

However, the infrared ray-absorbable eyeglasses lens described in WO-2008/133008 can only be suitable for absorbing infrared rays having a wavelength ranging between 780 nm and 2500 nm and cannot be suitable for additionally providing a function of absorbing ultraviolet rays or violet rays. Disadvantageously, the infrared ray-absorbable eyeglasses lens can cause a reduction of transmittance rates in a whole visible spectrum.

Further, another Japanese Patent Publication No. JPH-0943550, entitled “LENS FOR SPECTACLES,” discloses a spectacle lens device. The spectacle lens device can relieve to cause a dazzle effect of sunshine and has a material made of a synthetic resin based material.

As mentioned above, the synthetic resin based material includes an ultraviolet absorbent and a blue light absorbent which absorb rays having a wave length ranging between 550 nm and 585 nm to form a maximal absorption value of standard specific visual sensitivity curve and a minimal value of transmittance curve. The minimal value of transmittance curve is greater than or equal to 25%.

As mentioned above, the synthetic resin based material is provided to absorb rays having a wavelength ranging between 590 nm and 660 nm, with having an average transmittance greater than or equal to 15%. The synthetic resin based material is provided to absorb rays having a wavelength ranging between 470 nm and 550 nm, with having an average transmittance greater than or equal to 10%.

However, the spectacle lens device described in JPH-0943550 can only be suitable for absorbing ultraviolet rays and blue rays, and cannot be suitable for providing a function of absorbing both ultraviolet rays and high-energy violet rays. Disadvantageously, the spectacle lens device cannot enhance a whole visible spectrum and can cause a reduction of transmittance rates in a whole visible spectrum.

Further, another Japanese Patent Publication No. JPH-06324293, entitled “SPECTACLE LENS,” also discloses a spectacle lens device. The spectacle lens device includes infrared control means (i.e. infrared absorbent), a ultraviolet absorbent and a blue absorbent for filtering infrared rays, ultraviolet rays and blue rays.

As mentioned above, the infrared absorbent is selected from a dithiol-nickel complex, with the ultraviolet absorbent being selected from a benzophenone compound, with the blue being selected from a yellow dye. The spectacle lens device has a transmittance of visible light having a wavelength ranging between 450 nm and 750 nm, with having an average transmittance greater than or equal to 5%.

As mentioned above, the spectacle lens device has an average transmittance less than 3% in wavelength ranges of 200 nm to 400 nm and 780 nm to 950 nm, an average transmittance less than 3.5% in a wavelength range of 400 nm to 440 nm, and an average transmittance greater than or equal to 10% in a wavelength range of 450 nm to 730 nm.

However, the spectacle lens device described in JPH-06324293 can only be suitable for absorbing near infrared rays, ultraviolet rays and blue rays, and cannot be suitable for providing a function of absorbing both ultraviolet rays and high-energy violet rays. Disadvantageously, the spectacle lens device cannot enhance a whole visible spectrum and can cause a reduction of transmittance rates in a whole visible spectrum.

Further, another Chinese Patent Publication No. CN-115947919, entitled “LENS CAPABLE OF BLOCKING ULTRAVIOLET RAYS AND NEAR INFRARED RAYS, PREPARATION METHOD OF LENS AND SUNGLASSES WITH LENS,” discloses a lens device capable of blocking ultraviolet rays and near infrared rays. The lens device includes a composite modified material, a catalysis agent, a release agent, a composite dye material and a matrix monomer resin material.

As mentioned above, the composite modified material includes a near infrared dye and an ultraviolet absorbent which are mixed to form a mixture. The composite modified material is selectively provided with 1.0% to 2.0%, the catalysis agent is selectively provided with 0.01% to 0.05%, the release agent is selectively provided with 0.08% to 0.22%, the composite dye material is selectively provided with 0.3% to 0.5%, and the matrix monomer resin material is the balance.

As mentioned above, the composite modified material has a ratio of near infrared dye to ultraviolet absorbent as 20-30 mass units to 3-5 mass units. The near infrared dye further includes tungsten trioxide (WO₃) and toluene, with a ratio of tungsten trioxide to toluene as 30-50 weight units to 400-600 weight units.

As mentioned above, the ultraviolet absorbent (UV absorbent agent) includes 2-(3,5-Di-tert-butyl-2-hydroxyphenyl)-5-chlorobenzotriazole and 2-(2′-hydroxy-3′,5′-di-tert-butylphenyl)-5-chlorobenzotriazole. Furthermore, the ultraviolet absorbent of the composite modified material has a specific ratio of 2-(3,5-Di-tert-butyl-2-hydroxyphenyl)-5-chlorobenzotriazole to 2-(2′-hydroxy-3′,5′-di-tert-butylphenyl)-5-chlorobenzotriazole as 45-60 weight units to 40-62 weight units.

However, the lens device described in CN-115947919 can only be suitable for blocking near infrared rays and ultraviolet rays, and cannot be suitable for providing a function of absorbing both ultraviolet rays and high-energy violet rays. Disadvantageously, the lens device cannot enhance a whole visible spectrum and can cause a reduction of transmittance rates in a whole visible spectrum.

However, there is a need of improving the conventional lens devices for providing a function of absorbing both ultraviolet rays and high-energy violet rays with whole-visible-spectrum enhancement. The above-mentioned patent application publications are incorporated herein by reference for purposes including, but not limited to, indicating the background of the present invention and illustrating the situation of the art.

### SUMMARY OF THE INVENTION

The primary objective of this invention is to provide a near-infrared-filtering thermal-isolative optical lens device and method thereof for whole-visible-spectrum enhancement. The optical lens device includes a lens body and an optical filter provided therein. The lens body has an optical absorbance portion, including a violet & UV absorbent region, a red & NIR absorbent region and a whole-visible-spectrum transmittance region formed therebetween. The whole-visible-spectrum transmittance region is located between a first transmittance wavelength and a second transmittance wavelength, with the first transmittance wavelength located at 405 nm and the second transmittance wavelength located at 710 nm. The violet & UV absorbent region is provided to absorb a violet light and a UV light of beams while the red & NIR absorbent region is provided to absorb a red light and a NIR light of beams. Advantageously, the optical lens device of the present invention is successful in absorbing high-energy violet light and UV light and enhancing transmittance of whole visible spectrum.

The optical lens device in accordance with an aspect of the present invention includes:
a lens body having a first lens surface and a second lens surface, with the first lens surface provided at a first side of the lens body, with the second lens surface provided at a second side of the lens body;
an optical filter provided between the first side and the second side of the lens body; and
an optical absorbance portion provided in the optical filter, with the optical absorbance portion having a violet & UV absorbent region, a red & NIR absorbent region and a whole-visible-spectrum transmittance region provided therebetween, with transmitting a beam through the optical absorbance portion;
wherein the whole-visible-spectrum transmittance region is formed between the first transmittance wavelength and the second transmittance wavelength, the first transmittance wavelength is located at 405 nm and the second transmittance wavelength is located at 710 nm; and
wherein the violet & UV absorbent region is provided to absorb a violet light and a UV light of beams while the red & NIR absorbent region is provided to absorb a red light and a NIR light of beams to reduce an IR-heat transformed energy, with enhancing the beams with the whole-visible-spectrum transmittance region to provide an enhanced whole visible spectrum.

The infrared-filtering thermal-isolative optical method in accordance with another aspect of the present invention includes:
providing a lens body with an optical filter, with the lens body having an optical absorbance portion, with transmitting a beam through the optical absorbance portion;
providing an optical absorbance portion with a violet & UV absorbent region and a red & NIR absorbent region;
providing the optical absorbance portion with a whole-visible-spectrum transmittance region formed between the violet & UV absorbent region and the red & NIR absorbent region, with the whole-visible-spectrum transmittance region formed between a first transmittance wavelength and a second transmittance wavelength, with locating the first transmittance wavelength at 405 nm and locating the second transmittance wavelength at 710 nm; and
the violet & UV absorbent region absorbing a violet light and a UV light of beams and the red & NIR absorbent region absorbing a red light and a NIR light of beams to reduce an IR-heat transformed energy, with enhancing the beams with the whole-visible-spectrum transmittance region to provide an enhanced whole visible spectrum.

In a separate aspect of the present invention, the whole-visible-spectrum transmittance region has a maximum transmittance wavelength varying between a first maximum transmittance wavelength and a second maximum transmittance wavelength by adding at least one adjuster agent, with locating the first maximum transmittance wavelength at 490 nm or 495 nm and a second maximum transmittance wavelength at 515 nm or 520 nm.

In a further separate aspect of the present invention, the whole-visible-spectrum transmittance region has a maximum transmittance wavelength at 492 nm, 501 nm or 505 nm.

In yet a further separate aspect of the present invention, the first transmittance wavelength of the violet & UV absorbent region at 405 nm has an absorbance 100%.

In yet a further separate aspect of the present invention, the second transmittance wavelength of the red & NIR absorbent region at 710 nm has an absorbance greater than or equal to 96% as well as a transmittance less than or equal to 4%.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of an infrared-filtering thermal-isolative optical lens device in accordance with a first preferred embodiment of the present invention.

FIG. 2 is a schematic side view of an infrared-filtering thermal-isolative optical lens device in accordance with a second preferred embodiment of the present invention.

FIG. 2A is a schematic side view of an infrared-filtering thermal-isolative optical lens device in accordance with another preferred embodiment of the present invention.

FIG. 3 is a flow chart of an infrared-filtering thermal-isolative optical method in accordance with a preferred embodiment of the present invention.

FIG. 4 is a chart illustrating a first filtered spectral band of an infrared-filtering thermal-isolative optical lens device and method thereof in accordance with a preferred embodiment of the present invention.

FIG. 5 is a chart illustrating a second filtered spectral band of an infrared-filtering thermal-isolative optical lens device and method thereof in accordance with another preferred embodiment of the present invention.

FIG. 6 is a chart illustrating four filtered spectral bands of the infrared-filtering thermal-isolative optical lens devices and method thereof adjusted by adding various concentrations of adjuster agents in accordance with another preferred embodiment of the present invention.

FIG. 7 is a chart illustrating two filtered spectral bands of the infrared-filtering thermal-isolative optical lens devices and method thereof adjusted by further adding different concentrations of dyes in accordance with another preferred embodiment of the present invention.

FIG. 8 is a flow chart of a near-infrared-filtering thermal-isolative optical method in accordance with another preferred embodiment of the present invention.

FIG. 9 is a chart illustrating a third filtered spectral band of the near-infrared-filtering thermal-isolative optical lens devices and method thereof adjusted by further adding a predetermined dye in accordance with another preferred embodiment of the present invention.

### DETAILED DESCRIPTION OF THE INVENTION

It is noted that an infrared-filtering thermal-isolative optical lens device and method thereof for whole-visible-spectrum enhancement in accordance with the preferred embodiment of the present invention can be applicable to various glasses, various vision corrective glasses (i.e., ophthalmic glasses), various color deficient vision compensation glasses, various sunglasses, various smart glasses, various sport glasses (including motorcycle-riding glasses), various goggles, various VR wearable glasses devices, various AR wearable glasses devices or other optical devices such as 3D glasses, which are not limitative of the present invention.

FIG. 1 shows a schematic side view of an infrared-filtering thermal-isolative optical lens device in accordance with a first preferred embodiment of the present invention. Referring now to FIG. 1, the infrared-filtering thermal-isolative optical lens device in accordance with the first preferred embodiment of the present invention includes a first lens body 1, an optical filter 10 and an optical absorbance portion 2.

With continued reference to FIG. 1, by way of example, the first lens body 1 is formed from a curved-surface lens body such as a corrective glasses, a sunglasses, a sport glasses, a reading glasses, a helmet face shield, a safety helmet face shield (including welding helmet face shield), or other curved-surface lens bodies. The first lens body 1 is a transparent lens body with a preferred curvature.

Still referring to FIG. 1, by way of example, the first lens body 1 has a first lens surface 11 located at a first side (i.e. outer side as a light incident side) and a second lens surface 12 located at a second side (i.e. inner side as a light filtered side). The first lens body 1 is serially formed with a first filtering layer (or area) provided with a first dye material and a first additive material, a second filtering layer (or area) provided with a second dye material and a second additive material, and a third filtering layer (or area) provided with a third dye material and a third additive material.

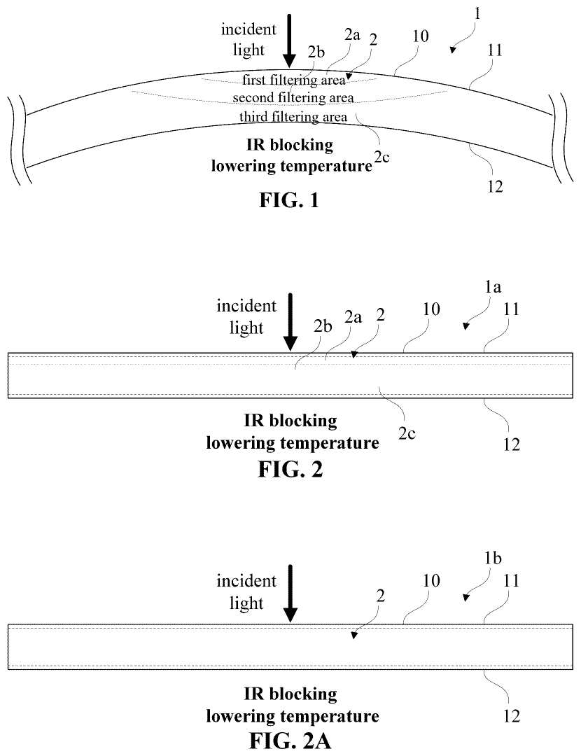

FIG. 2 shows a schematic side view of an infrared-filtering thermal-isolative optical lens device in accordance with a second preferred embodiment of the present invention, corresponding to that shown in FIG. 1. Turning now to FIG. 2, in comparison with the first embodiment, the infrared-filtering thermal-isolative optical lens device in accordance with the second preferred embodiment of the present invention includes a second lens body 1a, an optical filter 10 and an optical absorbance portion 2.

With continued reference to FIG. 2, by way of example, the second lens body 1a is formed from a flat-surface lens body, a thin layer lens body or a multiple layer lens body such as a TV screen glasses, a screen protector for 3C electronic devices, or other flat-surface lens bodies.

Referring back to FIGS. 1 and 2, by way of example, the optical filter 10 is suitably provided between the first lens surface 11 and the second lens surface 12 of the first lens body 1 or the second lens body 1a. Accordingly, the optical filter 10 is capable of filtering incident light from the first lens surface 11 to the second lens surface 12, as best shown by arrows in FIGS. 1 and 2.

Still referring to FIGS. 1 and 2, by way of example, the optical absorbance portion 2 is suitably provided at a preferred position of the optical filter 10. In a preferred embodiment, the optical absorbance portion 2 may be at the first lens surface 11 or the second lens surface 12. The optical absorbance portion 2 has a single-peak transmittance area and is made from at least one dye powder material, at least one absorbent agent material, at least one additive material and at least one diluting agent material. The dye powder material may be selected from FORESIGHT™ products (e.g., FDB-002, FDG-007 or other equivalent powder materials). The absorbent agent material may be selected from a blue violet & UV absorbent material (e.g., UNION UV-4C or other equivalent absorbent materials), a violet & UV absorbent material, an IR absorbent material (e.g., FORESIGHT™ products FS-IR780, FS-NIR780 or other equivalent absorbent materials) or other wavelength absorbent material. The diluting agent material may be selected from alcohol, isopropyl alcohol, ethylene glycol monobutyl ether or other diluting agents.

With continued reference to FIGS. 1 and 2, by way of example, the optical absorbance portion 2 has a violet & UV absorbent region, an IR absorbent region and a whole-visible-spectrum transmittance region provided therebetween. A light beam, as best shown by arrows in FIGS. 1 and 2, transmits through the optical absorbance portion 2 which filters it to form a spectrum band, with the optical absorbance portion 2 providing at least one violet & UV attenuation area and at least one IR attenuation area, as best shown by dotted lines in FIGS. 1 and 2. The attenuation areas of the optical absorbance portion 2 can be made of various concentrations of absorbent materials.

With continued reference to FIGS. 1 and 2, by way of example, the optical absorbance portion 2 includes a first optical absorbance portion 2a, a second optical absorbance portion 2b and a third optical absorbance portion 2c which are made of various different concentrations of dye powder materials, absorbent agent materials, additive materials and diluting agent materials. In a preferred embodiment, the first optical absorbance portion 2a, the second optical absorbance portion 2b and the third optical absorbance portion 2c of the optical absorbance portion 2 are selectively added with a predetermined dye material (e.g., blue dye, green dye or other color dyes).

With continued reference to FIGS. 1 and 2, by way of example, the first optical absorbance portion 2a, the second optical absorbance portion 2b and the third optical absorbance portion 2c of the optical absorbance portion 2 can be arranged with different orders of violet & UV absorbance layer and IR absorbance layer, according to various needs, to selectively absorb violet rays, UV rays and IR rays for whole-visible-spectrum enhancement.

FIG. 2A shows a schematic side view of an infrared-filtering thermal-isolative optical lens device in accordance with another preferred embodiment of the present invention, corresponding to that shown in FIG. 2. Referring now to FIGS. 2 and 2A, the infrared-filtering thermal-isolative optical lens device in accordance with the preferred embodiment of the present invention includes a third lens body 1b, an optical filter 10 and an optical absorbance portion 2, with integrating the first optical absorbance portion 2a, the second optical absorbance portion 2b and the third optical absorbance portion 2c, as best shown in FIG. 2, into a single layer to form the optical absorbance portion 2, as best shown in FIG. 2A.

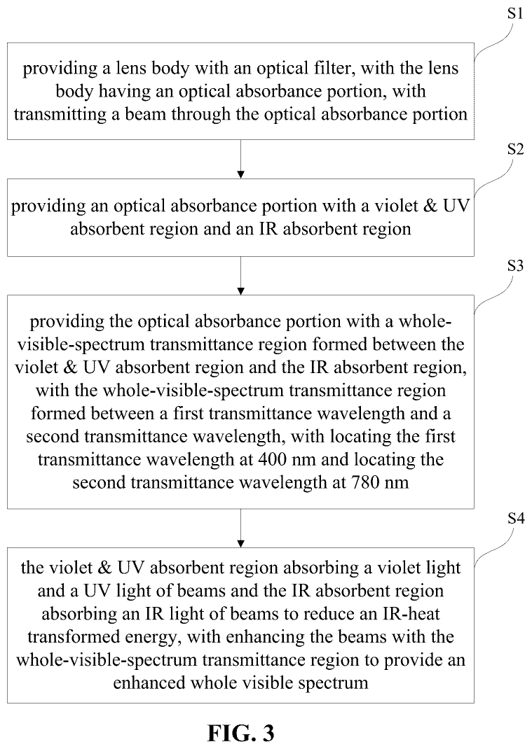

FIG. 3 shows a flow chart of an infrared-filtering thermal-isolative optical method in accordance with a preferred embodiment of the present invention. Referring now to FIGS. 1, 2, 2A and 3, by way of example, the infrared-filtering thermal-isolative optical method in accordance with a preferred embodiment of the present invention includes step 1: providing the lens body 1 with the optical filter 10, with the lens body 1 having the optical absorbance portion 2, with capable of transmitting a light beam (i.e., rays) through the optical absorbance portion 2.

Still referring now to FIGS. 1, 2, 2A and 3, by way of example, the lens body 1 is selectively made of a glass material, a plastic material, a polycarbonate (PC) material, a poly(methyl methacrylate) material (PMMA), a polyamide (PA) material, other similar materials or mixtures thereof.

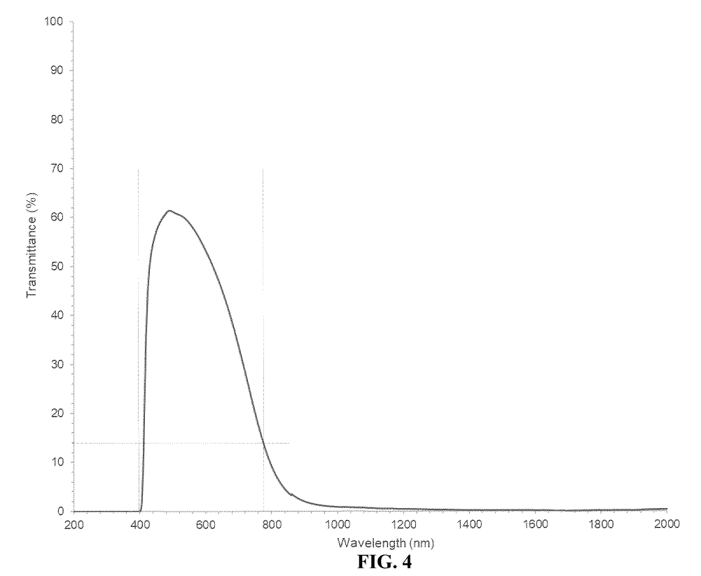

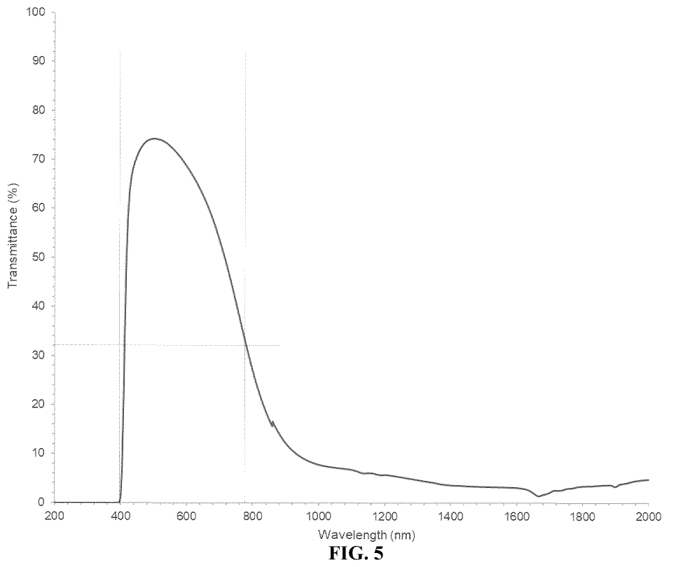

With continued reference to FIGS. 1, 2, 2A and 3, by way of example, the infrared-filtering thermal-isolative optical method in accordance with a preferred embodiment of the present invention includes step 2: providing the optical absorbance portion 2 with a violet & UV absorbent region having a wavelength less than 400 nm, as best shown at left portions in FIGS. 4 and 5, and an IR absorbent region having a wavelength greater than 780 nm, as best shown at middle portions in FIGS. 4 and 5.

With continued reference to FIGS. 1, 2, 2A and 3, by way of example, the infrared-filtering thermal-isolative optical method in accordance with a preferred embodiment of the present invention includes step 3: providing the optical absorbance portion 2 with a whole-visible-spectrum transmittance region, as best shown at left portions in FIGS. 4 and 5, formed between the violet & UV absorbent region and the IR absorbent region, with the whole-visible-spectrum transmittance region formed between a first transmittance wavelength and a second transmittance wavelength to provide an enhanced whole visible spectrum of incident light, with locating the first transmittance wavelength at 400 nm and locating the second transmittance wavelength at 780 nm.

With continued reference to FIGS. 1, 2, 2A and 3, by way of example, the infrared-filtering thermal-isolative optical method in accordance with a preferred embodiment of the present invention includes step 4: the violet & UV absorbent region is capable of absorbing a violet light and a UV light of beams and the IR absorbent region capable of absorbing an IR light of beams to reduce an IR-heat transformed energy and an increase of thermal heat thereof, with enhancing the beams with the whole-visible-spectrum transmittance region to provide an enhanced whole visible spectrum.

TABLE 1
Characteristics of infrared-filtering thermal-isolative optical lens device

| Sample ID | Thickness (mm) | Initial (° C.) | Radiated (° C.) | ΔT (° C.) | Infrared Blocking Rate (%) |
|---|---|---|---|---|---|
| Control (Air) | — | 23.5 | 36.8 | 13.3 | — |
| Normal PC | 1.3 | 23.5 | 36.8 | 13.3 | 17.09 |
| Normal PC | 1.7 | 23.7 | 36.5 | 12.8 | 18.55 |
| Normal PC | 2.0 | 23.6 | 36.3 | 12.7 | 20.19 |
| IRPC | 2.0 | 22.7 | 25.8 | 3.1 | 85.94 |
| IRBBHC | 2.0 | 24.2 | 27.3 | 3.1 | 84.31 |
| IRHCR40 | 2.0 | 23.7 | 26.7 | 3.0 | 85.71 |

As shown in Table 1, three samples of conventional optical lens devices (identified as Normal PC) and three samples of the infrared-filtering thermal-isolative optical lens device (identified as IRPC, IRBBHC and IRHCR40) made of FORESIGHT™ products FS-IR780 or FS-NIR780 of the present invention are and projected by a light beam as sunshine under tests. The three samples of conventional optical lens devices (Normal PC) have an increase of temperature about 36.8° C., 36.5° C. and 36.3° C., respectively. In comparison with the conventional optical lens devices, the three samples of the infrared-filtering thermal-isolative optical lens device (IRPC, IRBBHC and IRHCR40) of the present invention have a lower increase of temperature about 25.8° C., 27.3° C. and 26.8° C., respectively.

As further shown in Table 1, the three samples of conventional optical lens devices (Normal PC) have an increase rate of temperature (ΔT) about 13.3° C., 12.8° C. and 12.7° C., respectively. In comparison with the conventional optical lens devices, the three samples of the infrared-filtering thermal-isolative optical lens device (IRPC, IRBBHC and IRHCR40) of the present invention have a low increase rate of temperature (ΔT) about 3.1° C. and 3.0° C., respectively.

As further shown in Table 1, the three samples of conventional optical lens devices (Normal PC) have a blocking rate of IR about 17.09%, 18.55% and 20.19%, respectively. In comparison with the conventional optical lens devices, the three samples of the infrared-filtering thermal-isolative optical lens device (IRPC, IRBBHC and IRHCR40) of the present invention have blocking rate of IR about 85.94%, 84.31% and 85.71%, respectively.

FIG. 4 shows a chart illustrating a first filtered spectral band of an infrared-filtering thermal-isolative optical lens device and method thereof in accordance with a preferred embodiment of the present invention. Referring now to FIGS. 1, 2, 2A and 4, by way of example, the first filtered spectral band transmitting through the optical absorbance portion 2 has a single-peak transmittance area of whole visible spectrum, as best shown at left portion in FIG. 4, which are made from a preferred concentration of FORESIGHT™ products (e.g. λ_{Max}=432 nm). In a preferred embodiment, the preferred concentration of FORESIGHT™ is between about 0.003 g/kg PC and about 0.015 g/kg PC.

With continued reference to FIGS. 1, 2, 2A and 4, by way of example, the IR absorbent region and the whole-visible-spectrum transmittance region can be modified by an adjuster agent, with the IR absorbent region at wavelength 780 nm having an absorbance greater than or equal to 68% as well as a transmittance less than or equal to 32%, with the violet & UV absorbent region at wavelength 400 nm having an absorbance 100% as well as zero transmittance.

With continued reference to FIGS. 1, 2, 2A and 4, by way of example, the whole-visible-spectrum transmittance region can be modified by an adjuster agent, with the whole-visible-spectrum transmittance region having a maximum transmittance wavelength varying between a first maximum transmittance wavelength and a second maximum transmittance wavelength, with locating the first maximum transmittance wavelength at 490 nm and a second maximum transmittance wavelength at 505 nm.

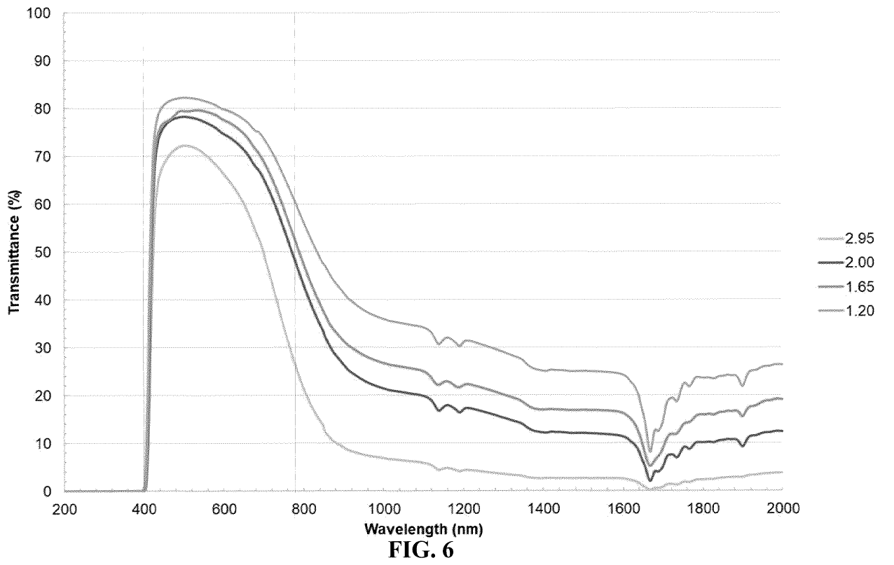

With continued reference to FIGS. 1, 2, 2A and 4, by way of example, the whole-visible-spectrum transmittance region can be modified by at least one adjuster agent, with the whole-visible-spectrum transmittance region having a maximum transmittance wavelength at about 490 nm or about 505 nm, as best shown at maximum peaks in FIG. 6.

FIG. 5 shows a chart illustrating a second filtered spectral band of an infrared-filtering thermal-isolative optical lens device and method thereof in accordance with another preferred embodiment of the present invention. Referring now to FIGS. 1, 2, 2A and 5, by way of example, the second filtered spectral band transmitting through the optical absorbance portion 2 has a single-peak transmittance area of whole visible spectrum, as best shown at left portion in FIG. 5, which are made from a preferred concentration of FORESIGHT™ products (e.g. λ_{Max}=501 nm). In a preferred embodiment, the preferred concentration of FORESIGHT™ is between about 0.003 g/kg PC and about 0.015 g/kg PC.

With continued reference to FIGS. 1, 2, 2A and 5, by way of example, the IR absorbent region and the whole-visible-spectrum transmittance region can be modified by an adjuster agent, with the IR absorbent region at wavelength 780 nm having an absorbance greater than or equal to 85% as well as a transmittance less than or equal to 15%, with the violet & UV absorbent region at wavelength 400 nm having an absorbance 100% as well as zero transmittance.

FIG. 6 shows a chart illustrating four filtered spectral bands of the infrared-filtering thermal-isolative optical lens devices and method thereof adjusted by adding various concentrations of adjuster agents in accordance with another preferred embodiment of the present invention. Referring now to FIGS. 1, 2, 2A and 6, by way of example, the infrared-filtering thermal-isolative optical lens devices and method thereof has adopted various adjuster agents (identified as 2.95, 2.00, 1.65, 1.20), with a first adjuster agent (as 2.95) having a highest effect of IR-blocking, with a second adjuster agent (as 2.00) having a higher effect of IR-blocking, with a third adjuster agent (as 1.65) having a high effect of IR-blocking, with a fourth adjuster agent (as 1.20) having a high effect of IR-blocking.

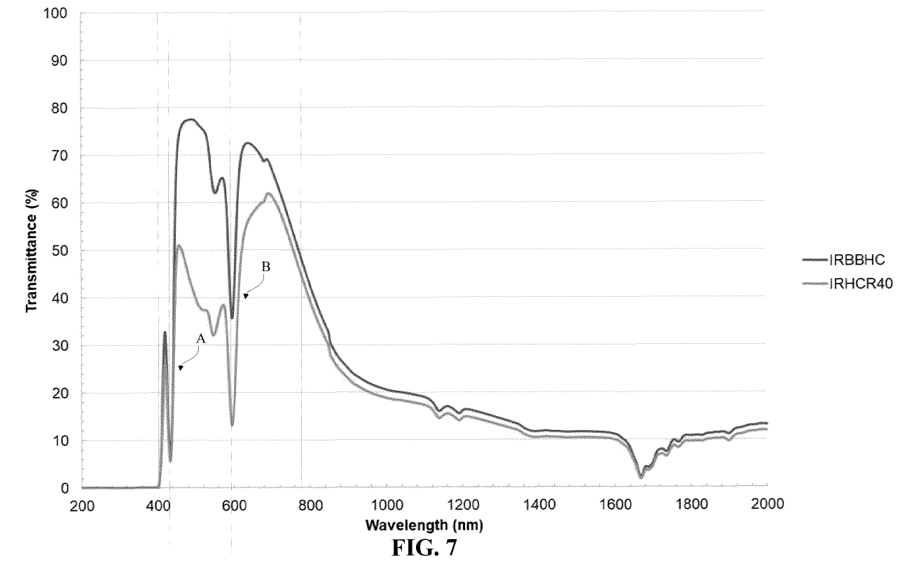

FIG. 7 shows a chart illustrating two filtered spectral bands of the infrared-filtering thermal-isolative optical lens devices and method thereof adjusted by further adding different concentrations of dyes in accordance with another preferred embodiment of the present invention. Referring now to FIGS. 1, 2, 2A and 7, by way of example, the optical absorbance portion 2 of the optical filter 10 is manufactured by further adding two dye materials (i.e., IRBBHC, IRHCR40, other dye materials or combinations thereof) such that the two filtered spectral bands are generated, as best shown in FIG. 7.

With continued reference to FIGS. 1, 2, 2A and 7, by way of example, the combinations of dye materials includes various FORESIGHT™ products (e.g., FDB-002 (whole-visible-spectrum transmittance region having an absorbance peak “A” with a maximum wavelength range between 431 nm and 433 nm or a maximum wavelength at about 432 nm, as best shown at leftmost portion in FIG. 7), FDG-007 (whole-visible-spectrum transmittance region having an absorbance peak “B” with a maximum wavelength range between 594 nm and 596 nm or a maximum wavelength at about 595 nm, as best shown at left portion in FIG. 7) or other functional dye materials) to obtain the two filtered spectral bands which has a greater function of IR filtering and a greater degree of thermal isolation.

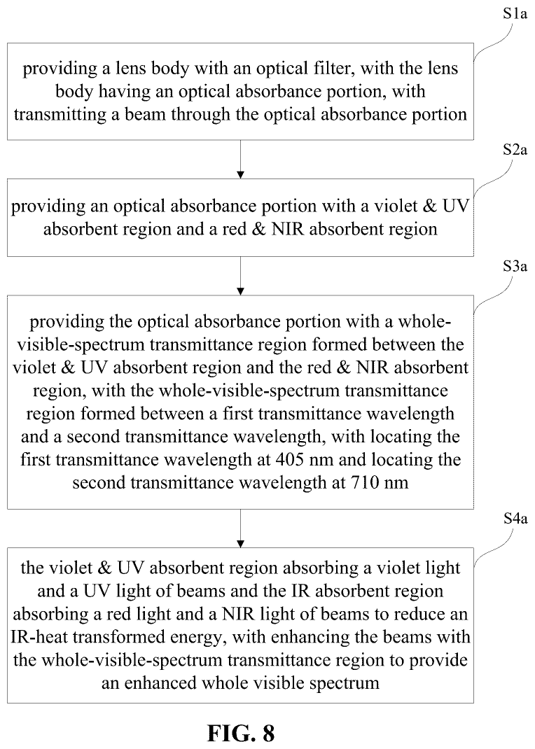

FIG. 8 is a flow chart of a near-infrared-filtering thermal-isolative optical method in accordance with another preferred embodiment of the present invention. Referring now to FIGS. 1, 2, 2A and 8, by way of example, the near-infrared-filtering thermal-isolative optical method in accordance with a preferred embodiment of the present invention includes step 1a: providing the lens body 1 with the optical filter 10, with the lens body 1 having the optical absorbance portion 2, with capable of transmitting a light beam (i.e., rays) through the optical absorbance portion 2.

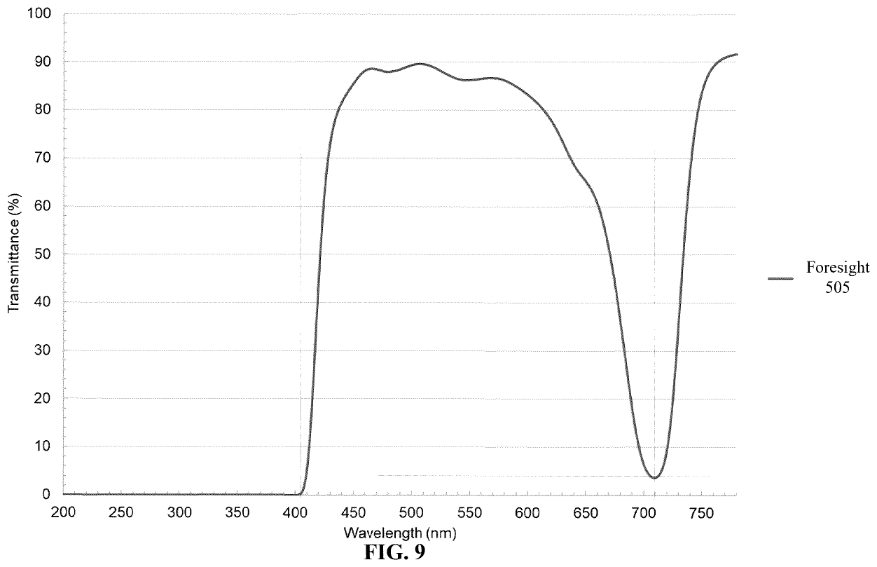

With continued reference to FIGS. 1, 2, 2A and 8, by way of example, the near-infrared-filtering thermal-isolative optical method in accordance with the preferred embodiment of the present invention includes step 2a: providing the optical absorbance portion 2 with a violet & UV absorbent region having a wavelength less than 405 nm, as best shown at left portion in FIG. 9, and a red & NIR absorbent region having a wavelength greater than 710 nm, as best shown at right portion in FIG. 9.

With continued reference to FIGS. 1, 2, 2A and 8, by way of example, the near-infrared-filtering thermal-isolative optical method in accordance with the preferred embodiment of the present invention includes step 3a: providing the optical absorbance portion 2 with a whole-visible-spectrum transmittance region, as best shown at middle portion in FIG. 9, formed between the violet & UV absorbent region and the red & NIR absorbent region, with the whole-visible-spectrum transmittance region formed between a first transmittance wavelength and a second transmittance wavelength to provide an enhanced whole visible spectrum of incident light, with locating the first transmittance wavelength at 405 nm and locating the second transmittance wavelength at 710 nm.

With continued reference to FIGS. 1, 2, 2A and 8, by way of example, the near-infrared-filtering thermal-isolative optical method in accordance with the preferred embodiment of the present invention includes step 4a: the violet & UV absorbent region is capable of absorbing a violet light and a UV light of beams and the red & NIR absorbent region capable of absorbing a red light and a NIR light of beams to reduce an IR-heat transformed energy and an increase of thermal heat thereof, with enhancing the beams with the whole-visible-spectrum transmittance region to provide an enhanced whole visible spectrum.

Generally, a high intensity of red light may cause damages of eyeballs and retina and has a thermal effect on it. The red light may cause a high degree of eye irritation so that there is a need of controlling the intensity and illumination of red light for protection eye while using it, e.g. properly absorbing parts of red light and near-infrared light.

FIG. 9 is a chart illustrating a third filtered spectral band of the near-infrared-filtering thermal-isolative optical lens devices and method thereof adjusted by further adding a predetermined dye in accordance with another preferred embodiment of the present invention. Referring now to FIGS. 1, 2, 2A and 9, by way of example, the third filtered spectral band transmitting through the optical absorbance portion 2 has a single-peak transmittance area of whole visible spectrum, as best shown at middle portion in FIG. 9, which are made from a preferred concentration of FORESIGHT™ products (e.g. λ_{Max}=505 nm). In a preferred embodiment, the preferred concentration of FORESIGHT™ is between about 0.003 g/kg PC and about 0.015 g/kg PC.

With continued reference to FIGS. 1, 2, 2A and 9, by way of example, the red & NIR absorbent region and the whole-visible-spectrum transmittance region can be modified by an adjuster agent, with the IR absorbent region at wavelength 710 nm having an absorbance greater than or equal to 96% as well as a transmittance less than or equal to 4%, with the violet & UV absorbent region at wavelength 405 nm having an absorbance 100% as well as zero transmittance.

With continued reference to FIGS. 1, 2, 2A and 9, by way of example, the whole-visible-spectrum transmittance region can be modified by an adjuster agent, with the whole-visible-spectrum transmittance region having a maximum transmittance wavelength varying between a first maximum transmittance wavelength and a second maximum transmittance wavelength, with locating the first maximum transmittance wavelength at 490 nm or 495 nm and a second maximum transmittance wavelength at 515 nm or 520 nm.

With continued reference to FIGS. 1, 2, 2A, 4, 5 and 9, by way of example, the whole-visible-spectrum transmittance region can be modified by at least one adjuster agent, with the whole-visible-spectrum transmittance region having a maximum transmittance wavelength at about 492 nm, as best shown at maximum peaks in FIG. 4, about 501 nm, as best shown at maximum peaks in FIG. 5, or about 505 nm, as best shown at maximum peaks in FIG. 9.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A near-infrared-filtering thermal-isolative optical lens device comprising:
a lens body having a first lens surface and a second lens surface, with the first lens surface provided at a first side of the lens body, with the second lens surface provided at a second side of the lens body;
an optical filter provided between the first side and the second side of the lens body; and
an optical absorbance portion provided in the optical filter, with the optical absorbance portion having a violet & UV absorbent region, a red & NIR absorbent region and a whole-visible-spectrum transmittance region provided therebetween, with transmitting a beam through the optical absorbance portion;
wherein the whole-visible-spectrum transmittance region is formed between the first transmittance wavelength and the second transmittance wavelength, the first transmittance wavelength is located at 405 nm and the second transmittance wavelength is located at 710 nm; and
wherein the violet & UV absorbent region is provided to absorb a violet light and a UV light of beams while the red & NIR absorbent region is provided to absorb a red light and a NIR light of beams to reduce an IR-heat transformed energy, with enhancing the beams with the whole-visible-spectrum transmittance region to provide an enhanced whole visible spectrum.

2. The near-infrared-filtering thermal-isolative optical lens device as defined in claim 1, wherein the whole-visible-spectrum transmittance region has a maximum transmittance wavelength varying between a first maximum transmittance wavelength and a second maximum transmittance wavelength by adding at least one adjuster agent, with locating the first maximum transmittance wavelength at 490 nm and a second maximum transmittance wavelength at 505 nm.

3. The near-infrared-filtering thermal-isolative optical lens device as defined in claim 1, wherein the whole-visible-spectrum transmittance region has a maximum transmittance wavelength at 492 nm or 501 nm.

4. The near-infrared-filtering thermal-isolative optical lens device as defined in claim 1, wherein the first transmittance wavelength of the violet & UV absorbent region at 400 nm has an absorbance 100%.

5. The near-infrared-filtering thermal-isolative optical lens device as defined in claim 1, wherein the second transmittance wavelength of the IR absorbent region at 780 nm has an absorbance greater than or equal to 68% as well as a transmittance less than or equal to 32%.

6. The near-infrared-filtering thermal-isolative optical lens device as defined in claim 1, wherein the second transmittance wavelength of the IR absorbent region at 780 nm has an absorbance greater than or equal to 85% as well as a transmittance less than or equal to 15%.

7. The near-infrared-filtering thermal-isolative optical lens device as defined in claim 1, wherein the optical absorbance portion of the optical filter is manufactured by further adding at least one dye material to have a first absorbance peak with a first maximum wavelength range between 431 nm and 433 nm or a second absorbance peak with a second maximum wavelength range between 594 nm and 596 nm.

8. A near-infrared-filtering thermal-isolative optical method comprising:
providing a lens body with an optical filter, with the lens body having an optical absorbance portion, with transmitting a beam through the optical absorbance portion;
providing an optical absorbance portion with a violet & UV absorbent region and a red & NIR absorbent region;
providing the optical absorbance portion with a whole-visible-spectrum transmittance region formed between the violet & UV absorbent region and the IR absorbent region, with the whole-visible-spectrum transmittance region formed between a first transmittance wavelength and a second transmittance wavelength, with locating the first transmittance wavelength at 405 nm and locating the second transmittance wavelength at 710 nm; and
the violet & UV absorbent region absorbing a violet light and a UV light of beams and the red & NIR absorbent region absorbing a red light and a NIR light of beams to reduce an IR-heat transformed energy, with enhancing the beams with the whole-visible-spectrum transmittance region to provide an enhanced whole visible spectrum.

9. The near-infrared-filtering thermal-isolative optical method as defined in claim 8, wherein the whole-visible-spectrum transmittance region has a maximum transmittance wavelength varying between a first maximum transmittance wavelength and a second maximum transmittance wavelength by adding at least one adjuster agent, with locating the first maximum transmittance wavelength at 490 nm and a second maximum transmittance wavelength at 505 nm.

10. The near-infrared-filtering thermal-isolative optical method as defined in claim 8, wherein the whole-visible-spectrum transmittance region has a maximum transmittance wavelength at 492 nm or 501 nm.

11. The near-infrared-filtering thermal-isolative optical method as defined in claim 8, wherein the first transmittance wavelength of the violet & UV absorbent region at 400 nm has an absorbance 100%.

12. The near-infrared-filtering thermal-isolative optical method as defined in claim 8, wherein the second transmittance wavelength of the IR absorbent region at 780 nm has an absorbance greater than or equal to 68% as well as a transmittance less than or equal to 32%.

13. The near-infrared-filtering thermal-isolative optical method as defined in claim 8, wherein the second transmittance wavelength of the IR absorbent region at 780 nm has an absorbance greater than or equal to 85% as well as a transmittance less than or equal to 15%.

14. The near-infrared-filtering thermal-isolative optical method as defined in claim 8, wherein the optical absorbance portion of the optical filter is manufactured by further adding at least one dye material to have a first absorbance peak with a first maximum wavelength range between 431 nm and 433 nm or a second absorbance peak with a second maximum wavelength range between 594 nm and 596 nm.
